(19) United States
(12) Patent Application Publication
(10) Pub. No.: US 2004/0267597 A1
(43) Pub. Date: Dec. 30, 2004

(54) Generating an interactive display survey for suppliers with subsets of questions delimited based upon assessments of the quality levels of quality attributes of the suppliers

(75) Inventors: Walid Kobrosly, Round Rock, TX (US); Carol Angela Logan, Austin, TX (US); Katherine June Pearsall, Georgetown, TX (US); Charles Gorham Ward, Austin, TX (US)

Correspondence Address: Mark E. McBurney, International Business Machines Corporation, Intellectual Property Law Department, Internal Zip 4054, 11400 Burnet Road, Austin, TX, 78758, US

(73) Assignee: International Business Machines Corporation, Armonk, NY

(21) Appl. No.: 10/607,458

(22) Filed: Jun. 26, 2003

(51) Int. Cl. G06F 17/60

(52) U.S. Cl. 705/10

(57) ABSTRACT

A computer controlled display system for generating quality assurance surveys to be interactively taken by suppliers on computer display systems that will aid those making purchasing decisions to select suppliers that are most likely to provide products having the quality assurance required by the purchasers. The quality level of each of a set of quality attributes of a component supplier are assessed and there is generated for each of the quality attributes a template for delimiting subsets of the plurality of questions in the survey database being presented to said supplier based upon the quality level of the attribute. In operation of the system, the assessing of the quality level includes determining one of a plurality of quality levels for each of the set of quality attributes and the template for delimiting subsets of questions includes generating a different subset of questions for each of the quality levels for each attribute.

### TECHNICAL FIELD

The present invention relates to a method and system of doing business using an interactive computer controlled display system and method as an aid in generating sets of interactive questions in computer surveys made of computer component suppliers.

### BACKGROUND OF RELATED ART

Over the past generation, businesses have been undergoing major changes in the ways that they conduct their business. One of the most dramatic trends has been in the reduction of employees, functions and facilities through the out-sourcing of virtually anything that can be out-sourced. This has made many businesses leaner and more competitive with significantly reduced staffs and facilities to be maintained. However, along with these advantages has come a loss in control of the performance of many functions, as well as a diminished ability to control the quality of the resulting products.

This diminished control on the part of the business developers of products or systems becomes more pronounced in two major business functions in the computer industry. First, in the area of OEM (Other Equipment Manufacturers) supplied components, the need for qualified suppliers who will provide units that the product developer and seller incorporate into their products is clearly apparent. Any defect in an OEM may bring down a whole product line. Likewise, a failure to meet scheduling commitments on the part of OEMs could do the same.

Suppliers of software also present quality assurance problems to developers of computer systems who are potential purchasers. Over its first forty years, prior to the 1980's, the software development environment was one in which an individual or a small dedicated group willing to put in long hard hours could create “elegant” software or “killer applications” directed to and effective in one or more of the limited computer system environments existing at the time. Unlike hardware or industrial product development, the development of software did not require substantial investment in capital equipment and resources. Consequently, in the software product field, the business and consumer marketplace to which the software is directed has traditionally expected short development cycles from the time that a computer need and demand became apparent to the time that a commercial software product fulfilling the need became available.

Unfortunately, with the explosion of computer usage and the resulting wide diversity of computer systems that must be supported by, or at least not incompatible with, each newly developed computer software product, the development cycles have become very complex. Even when the software product development is an upgrade of an existing product, every addition, subtraction or modification of the program could have an insignificant or a profound effect on another operating system or application program that must be supported.

During the evolution of the software industries over the past two decades it has been evident that developing software will be combined in new, often unforeseen, ways, and, thus, there is an increased likelihood that the individual developments will drive system programs that must be supported into inoperable states for certain purposes or under certain conditions. This changed development environment has caused many traditional and responsible software development houses to take the time and make the effort to resolve all potential incompatibilities with all existing and standard software before the new developed software products were commercially released. Unfortunately, the computer industry landscape is littered with the “corpses” of such responsible longer development cycle software houses that lost out to newer software product entrepreneurs that rushed to the market, or to buyers with products that were less than complete.

Whether the customer of a software supplier is acquiring the software for specific internal needs or to be incorporated into broader products to be marketed by the customer, dysfunctional software products from even one supplier can derail an entire enterprise with profound marketing or economic effects. Accordingly, processes and systems do exist for assessing the quality levels of software suppliers. Copending U.S. patent application Ser. No. 09/710,920, Timothy A. Dietz et al., Business Method for Performing qualifications of Software and Software Development Organizations, filed Nov. 9, 2000, and assigned to the same assignee of the present invention, provides an effective method for accessing the quality of software suppliers.

Unfortunately, because of the extensive need for software suppliers due to extensive business out-sourcing, together with the high turnover in reliable software suppliers, it may often be difficult for system developers to get software suppliers of known reliability to provide for their software requirements on the developer's schedules. Consequently, it may often be the case that the software supplier may be less than the best available supplier or may be of relatively unknown quality.

It is not enough that the software supplier provide the customer with financial guarantees as to quality and schedules. The suppliers often will not have the resources to make up for the substantial losses that may result from defective software.

In view of all of the above circumstances, the purchasers from both OEM suppliers and software suppliers in general are in need of processes for assuring the qualifications and reliability of such suppliers.

### SUMMARY OF THE PRESENT INVENTION

The present invention provides a computer controlled display system for generating quality assurance surveys to be interactively taken by suppliers on computer display systems that will aid those making purchasing decisions to select suppliers that are most likely to provide products having the quality assurance required by the purchasers. The invention involves the combination of assessing the quality level of each of a set of quality attributes of a component supplier, and generating for each of the quality attributes a template for delimiting subsets of the plurality of questions in the survey database being presented to said supplier based upon the quality level of the attribute. In operation of the system, the means for assessing the quality level includes means for determining one of a plurality of quality levels for each of the set of quality attributes, and the template means for delimiting subsets of questions includes means for generating a different subset of questions for each of the quality levels for each attribute. The means for determining the quality levels may determine such levels dynamically during the system operation.

In accordance with an aspect of the invention, the set of quality attributes consists of a single overall quality characteristic having several predetermined quality levels and the means for generating generates a different subset of questions for each of said quality levels.

The invention also comprehends means for determining a purchaser's needs wherein the set of quality attributes of the suppliers are based upon these purchaser's needs. Such quality attributes could be based upon the management processes of the supplier or supplier risk identification and reduction.

### BRIEF DESCRIPTION OF THE DRAWINGS

The present invention will be better understood and its numerous objects and advantages will become more apparent to those skilled in the art by reference to the following drawings, in conjunction with the accompanying specification, in which:

FIG. 1 is a block diagram of a data processing system including a central processing unit and network connections via a communications adapter that is capable of functioning as an interactive user's computer controlled display on which the display system of the present invention may be used to present surveys;

FIG. 2 is a diagrammatic view of a display screen on a computer terminal shown in FIG. 1 wherein the user has entered the name of a proposed supplier and the system has provided the supplier's assessed quality level with respect to one attribute, and has delimited a subset of questions based upon this quality level;

FIG. 3 is a diagrammatic view like that of FIG. 2 wherein the name of a different proposed supplier has been entered resulting in a different assessed quality level for the attribute and, accordingly, a different delimited subset of questions;

FIG. 4 is a diagrammatic view like that of FIGS. 2 and 3 wherein the name of yet another proposed supplier has been entered resulting in a different assessed quality level for the attribute and, accordingly, a different delimited subset of questions;

FIG. 5 is an illustrative flowchart describing the setting up of the process of the present invention for the generation of quality assurance supplier survey templates delimiting subsets of survey questions based upon quality levels of given attributes; and

FIG. 6 is a flowchart of an illustrative run of the process setup in FIG. 5.

### DETAILED DESCRIPTION OF THE PREFERRED EMBODIMENT

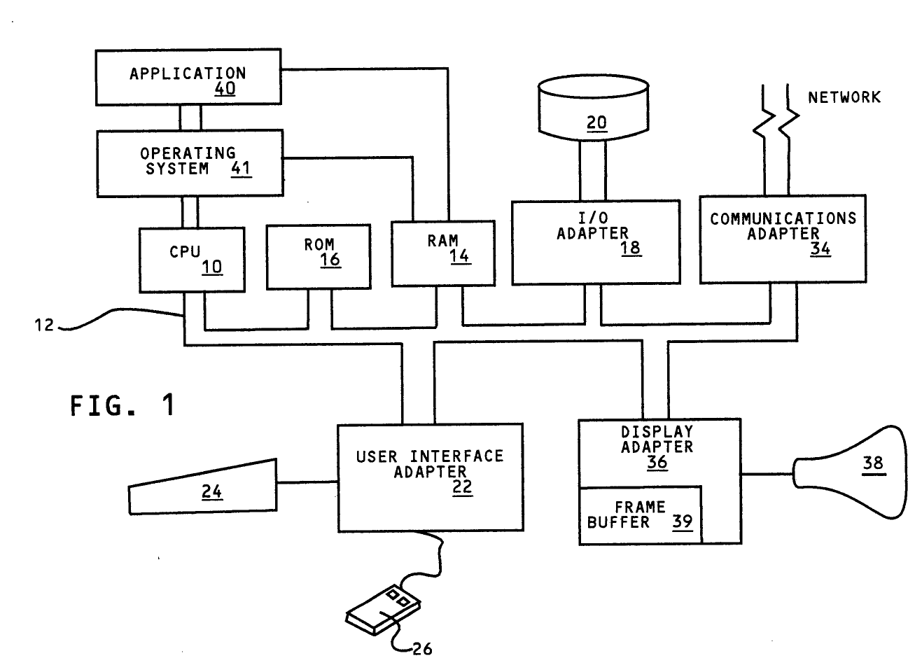

Referring to FIG. 1, a typical data processing terminal is shown that may function as the computer controlled display terminals for the generation of quality assurance supplier survey templates delimiting subsets of survey questions based upon quality levels of given attributes in accordance with the present invention. A central processing unit (CPU) 10, such as one of the PC microprocessors or workstations, e.g. eserver pseries available from International Business Machines Corporation (IBM), or Dell PC microprocessors, is provided and interconnected to various other components by system bus 12. An operating system 41 runs on CPU 10, provides control and is used to coordinate the function of the various components of FIG. 1. Operating system 41 may be one of the commercially available operating systems, such as IBM's AIX 6000™ operating system or Microsoft's WindowsMe™ or Windows 2000™, as well as UNIX and other IBM operating systems. Application programs 40, controlled by the system, are moved into and out of the main memory Random Access Memory (RAM) 14. These programs include the program of the present invention for the generation of quality assurance supplier survey templates delimiting subsets of survey questions based upon quality levels of given attributes that will hereinafter be described in greater detail. A Read Only Memory (ROM) 16 is connected to CPU 10 via bus 12 and includes the Basic Input/Output System (BIOS) that controls the basic computer functions. RAM 14, I/O adapter 18 and communications adapter 34 are also interconnected to system bus 12. I/O adapter 18 may be a Small Computer System Interface (SCSI) adapter that communicates with the disk storage device 20. Communications adapter 34 interconnects bus 12 with an outside Internet or Web network. I/O devices are also connected to system bus 12 via user interface adapter 22 and display adapter 36. Keyboard 24 and mouse 26 are all interconnected to bus 12 through user interface adapter 22. It is through such input devices that the user may interactively relate to the programs for generating contract requirements.

Display adapter 36 includes a frame buffer 39 that is a storage device that holds a representation of each pixel on the display screen 38. Images may be stored in frame buffer 39 for display on monitor 38 through various components, such as a digital to analog converter (not shown) and the like. By using the aforementioned I/O devices, a user is capable of inputting information to the system through the keyboard 24 or mouse 26 and receiving output information from the system via display 38.

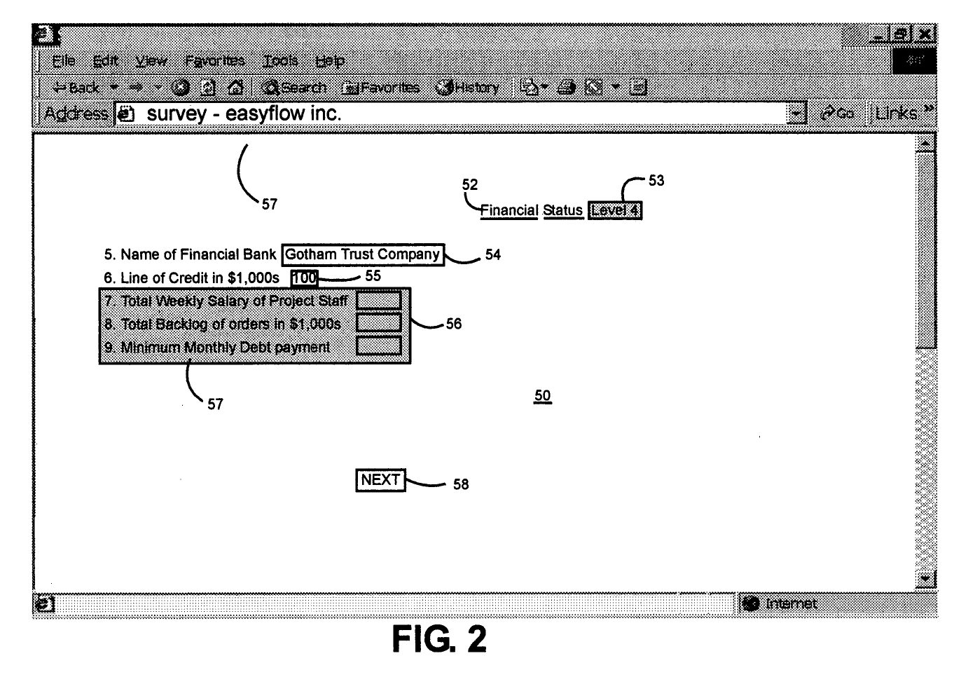

With reference to FIG. 2, an illustrative display screen for the presentation to suppliers of surveys to establish the quality assurance potential of a supplier. The user has entered the name of a proposed supplier and the system has provided the supplier's assessed quality level with respect to one attribute and has delimited a subset of questions based upon this quality level. In this example, the user has entered the supplier's name 51, “Easyflow Inc.”, and the system has provided a quality level 53 of “Level 4”. This is not usually shown on display screen 50 and is consequently shown cross-hatched to indicate that it is normally hidden from display view. For purposes of the present illustration, the quality assessment rating levels are on a scale of 1 through 5 with 1 being the highest quality rating and 5 being the lowest rating. How the software supplier is being assessed is not a function of the present invention. The above-referenced patent application Ser. No. 09/710,920, offers a convenient process for assessment of software suppliers. New suppliers may be given a quality assessment level based upon interviews, visits to facilities and responses to data entry computer dialogues. Of course suppliers with whom the user has had business experience may be assessed upon such business experience. The illustration shown in FIG. 2 involves a “Financial Status” attribute 52. Based on an attribute rating of Level 4, the supplier taking the survey is only presented with a set of questions that at the survey point in the illustration includes questions 54 and 55. The template 56 blocks the other questions 57 that are not presented to the survey taker. This is indicated by the template cross-hatching showing that questions “7-9” are hidden. The cross-hatching is used to illustrate that these questions are logically hidden by the template rather than being physically hidden on the screen. Of course, this is an illustration of a portion of a survey wherein the survey taker may then go on the next segment by clicking on “Next” button 58.

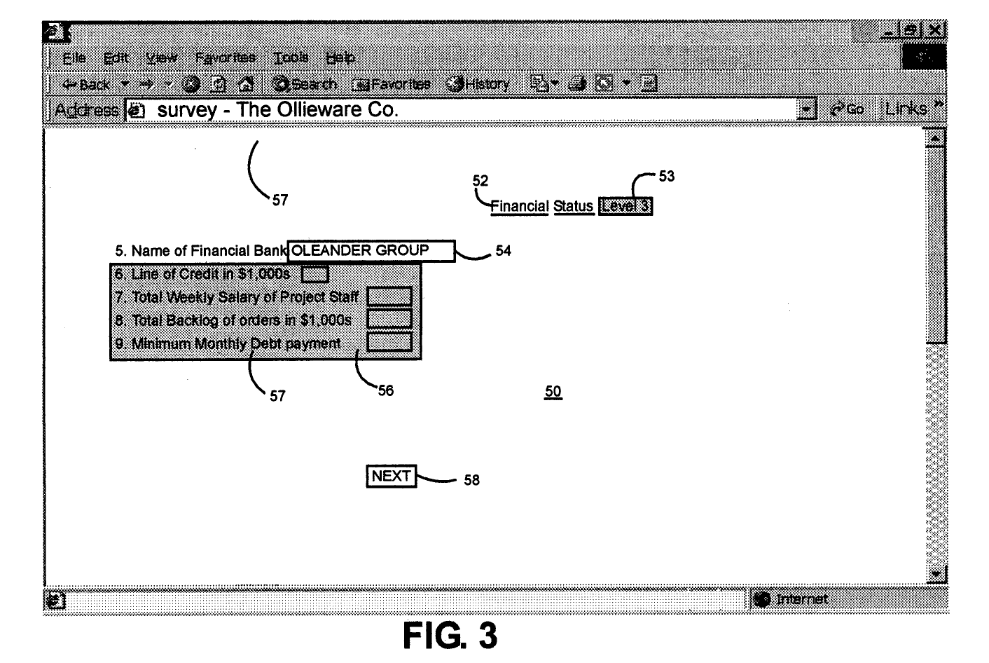

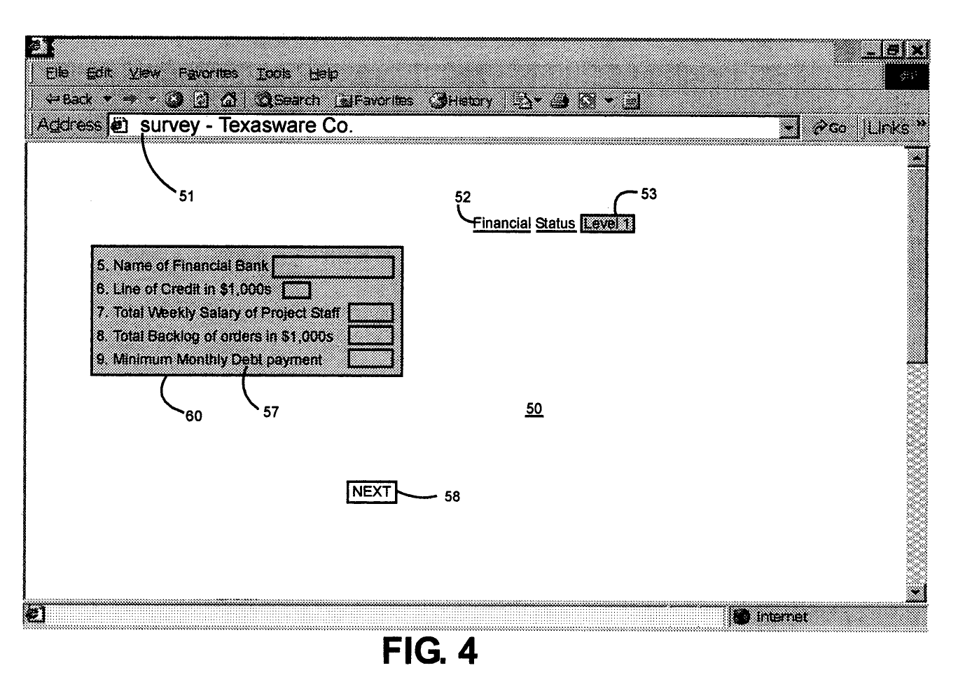

FIG. 3 is a diagrammatic view like that of FIG. 2 wherein a different proposed supplier, “Ollieware Co.” 51 has been entered as taking the survey resulting in a different assessed quality level 53 of “3” for the “Financial Status” attribute 52. Accordingly, template 56 has delimited a different subset of questions wherein only question 54 need be answered. Likewise, FIG. 4 is a diagrammatic view like that of FIG. 2 wherein a different proposed supplier, “Texasware Co.” 51 has been entered as taking the survey resulting in a different but highest assessed quality level 53 of “1” for the “Financial Status” attribute 52. Accordingly, template 60 has delimited a different subset of questions wherein none of question set 57 need be answered at this segment of the survey.

In the illustration, financial status should be considered as one of a set or plurality of quality attributes that any proposed supplier may be surveyed on, e.g. production facilities, second sources, delivery schedule reliability, etc. On the other hand, the proposed supplier may be assigned a single overall general quality assessment with the same set of rating levels.

The templates delimiting subsets of questions may be predetermined and stored so that as a particular quality level for a particular attribute is determined, its corresponding predetermined template may be accessed from storage and used to define the set of questions to be displayed to the supplier being surveyed. It should also be noted that the quality levels of suppliers may be continuously and automatically modified as the user's experience with the particular supplier develops.

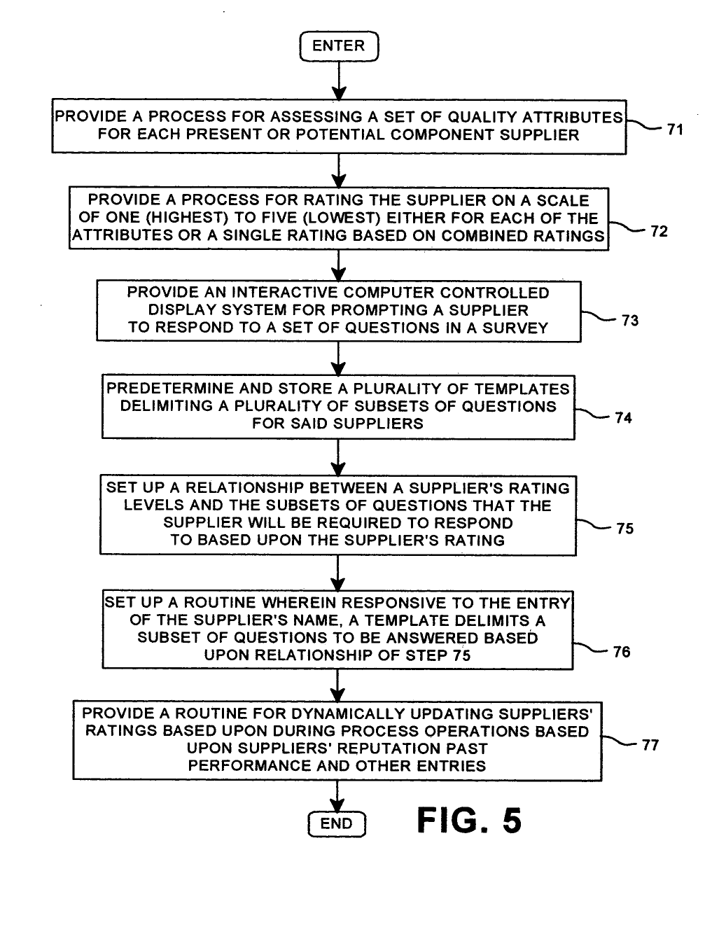

With reference to the flowchart of FIG. 5, there will be described an illustrative process of how the process of the present invention is set up. A process is provided for assessing a set of quality attributes for each present or potential OEM or software supplier, step 71. Then, there is set up a process for rating any supplier on a scale of one to five for each of the set of attributes or as a single quality level based upon the combined attribute ratings, step 72. A supplier survey system is set up for prompting a supplier through an interactive display system to respond to sets of questions, step 73. There are predetermined and stored a plurality of templates for delimiting sets of questions to be presented to suppliers to ensure a satisfactory product from the supplier, step 74. A relationship between a supplier's rating levels and the templates delimiting the sets of questions that the supplier will be required to answer in the survey, based upon either an overall single general attribute rating or based upon each attribute rating, is set up, step 75. There is set up a routine, step 76, wherein responsive to the entry of the supplier's name, a template delimits a set of questions to be answered based upon the relationship set up in step 75. There is provided a routine for dynamically updating the suppliers' ratings during process operations based upon suppliers' performance and other entries, step 77.

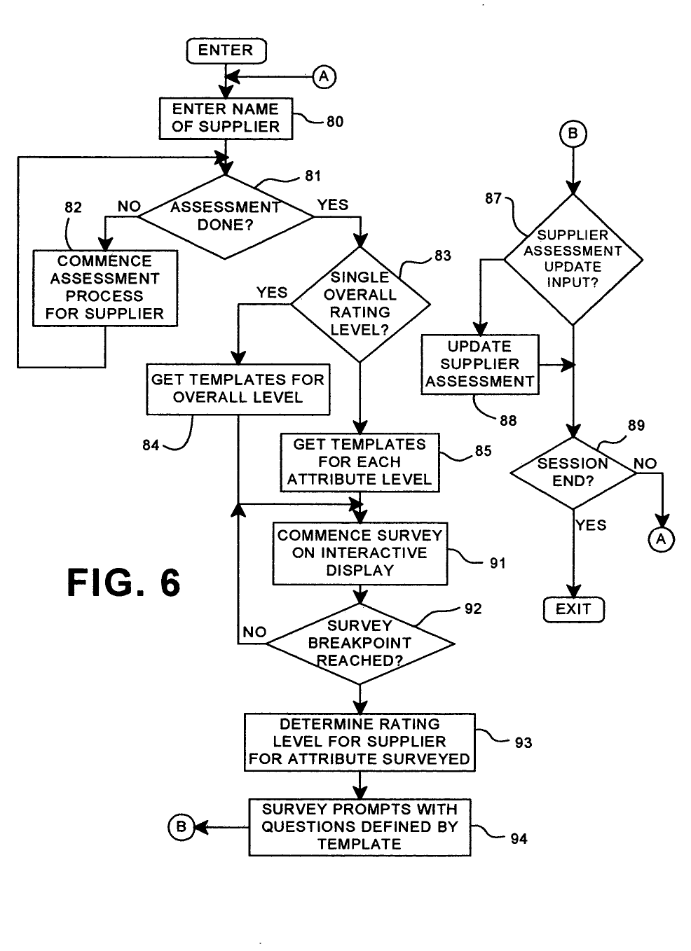

With respect to FIG. 6, there will now be described a running of the process set up in FIG. 5. To initiate the survey, the name of the proposed supplier is entered, step 80. A determination is made as to whether an assessment has already been completed for the supplier, step 81. If No, the supplier is set up for an assessment by any of the techniques described above, step 82, and the process is returned to step 81 where the completion of an assessment is awaited for determination. If the determination in step 81 is Yes, then a further determination is made, step 83, as to whether the supplier is assessed with a single overall combined rating level. If Yes, the predetermined survey templates for that level are retrieved from storage, step 84. If No, then the predetermined survey templates for each attribute level are retrieved from storage, step 85. In either case, the supplier survey is commenced on the interactive display terminal, step 91. During the taking of the supplier survey, determinations are made as to whether breakpoints have been reached in responding to questions, step 92. A breakpoint is meant to be a point in the survey at which a determination needs to be made as to whether a particular template must be used based upon the level rating of the supplier for the attribute being surveyed. If No, the process is returned to step 91 and the survey continued. If Yes, then the level rating for the supplier is obtained, step 93, and the template appropriate for that level is used to delimit the set of questions presented to the supplier in the survey, step 94. At this point, assessment updates may be conveniently illustrated. The process branches (Branch B) to step 87 where a determination is made as to whether there has been an assessment update for the supplier being surveyed. If Yes, the supplier assessment is updated, step 88. Then, or if the determination in step 87 is No, a determination may conveniently be made as to whether the session is at an end, step 89. If Yes, the session is ended. If No, the process is returned to initial step 80 via branch “A”.

A convenient implementation of the present invention is in an application program 40 made up of programming steps or instructions resident in RAM 14, FIG. 1, of the process management server computers during various operations. Until required by the computer system, the program instructions may be stored in another readable medium, e.g. in disk drive 20, or in a removable memory such as an optical disk for use in a CD ROM computer input, or in a floppy disk for use in a floppy disk drive computer input. Further, the program instructions may be stored in the memory of another computer prior to use in the system of the present invention and transmitted over a Local Area Network (LAN) or a Wide Area Network (WAN), such as the Internet, when required by the user of the present invention. One skilled in the art should appreciate that the processes controlling the present invention are capable of being distributed in the form of computer readable media of a variety of forms.

Although certain preferred embodiments have been shown and described, it will be understood that many changes and modifications may be made therein without departing from the scope and intent of the appended claims.

What is claimed is:

1. A computer controlled display system for generating quality assurance interactive display surveys for computer component suppliers comprising:
means for assessing the quality level of each of a set of quality attributes of said suppliers;
means for presenting to each supplier on said display system, a plurality of questions to be interactively answered by a supplier; and
template means for delimiting subsets of said plurality of questions being presented to said supplier for each of said quality attributes based upon the quality level of said attribute.

2. The computer controlled display system of claim 1 wherein:
said means for assessing the quality level includes means for determining one of a plurality of quality levels for each of said set of quality attributes, and
said template means for delimiting subsets of questions includes means for generating a different subset of questions for each of said quality levels for each attribute.

3. The computer controlled display system of claim 2 wherein said means for determining said quality levels determines said levels dynamically during the system operation.

4. The computer controlled display system of claim 2 wherein:
said set of quality attributes consists of a single overall quality characteristic having several predetermined quality levels, and
said means for generating generates a different subset of questions for each of said quality levels.

5. The computer controlled display system of claim 2 further including:
means for determining a purchaser's needs; and
wherein said set of quality attributes of said suppliers are based upon said purchaser's needs.

6. The computer controlled display system of claim 2 wherein at least one of said set of quality attributes involves the management processes of said supplier.

7. The computer controlled display system of claim 2 wherein at least one of said set of quality attributes involves supplier risk identification and reduction.

8. A Method for generating on a computer controlled display system quality assurance interactive display surveys for computer component suppliers comprising:
assessing the quality level of each of a set of quality attributes of said suppliers;
presenting to each supplier on said display system, a plurality of questions to be interactively answered by a supplier; and
delimiting subsets of said plurality of questions being presented to said supplier for each of said quality attributes based upon the quality level of said attribute.

9. The method of claim 8 wherein:
said step of assessing the quality level includes the step of determining one of a plurality of quality levels for each of said set of quality attributes, and
said step of delimiting subsets of questions includes the step of generating a different subset of questions for each of said quality levels for each attribute.

10. The method of claim 9 wherein said step of determining said quality levels determines said levels dynamically during the system operation.

11. The method of claim 9 wherein:
said set of quality attributes consists of a single overall quality characteristic having several predetermined quality levels, and
said step of generating provides a different subset of questions for each of said quality levels.

12. The method of claim 9 further including:
the step of determining a purchaser's needs; and
wherein said set of quality attributes of said suppliers are based upon said purchaser's needs.

13. The method of claim 9 wherein at least one of said set of quality attributes involves the management processes of said supplier.

14. The method of claim 9 wherein at least one of said set of quality attributes involves supplier risk identification and reduction.

15. A computer program having program code included on a computer readable medium operable in a computer controlled display system for generating quality assurance interactive display surveys for computer component suppliers comprising:
means for assessing the quality level of each of a set of quality attributes of said suppliers;
means for presenting to each supplier on said display system, a plurality of questions to be interactively answered by a supplier; and
template means for delimiting subsets of said plurality of questions being presented to said supplier for each of said quality attributes based upon the quality level of said attribute.

16. The computer program of claim 15 wherein:
said means for assessing the quality level includes means for determining one of a plurality of quality levels for each of said set of quality attributes, and
said template means for delimiting subsets of questions includes means for generating a different subset of questions for each of said quality levels for each attribute.

17. The computer program of claim 16 wherein said means for determining said quality levels determines said levels dynamically during the system operation.

18. The computer program of claim 16 wherein:
said set of quality attributes consists of a single overall quality characteristic having several predetermined quality levels, and
said means for generating generates a different subset of questions for each of said quality levels.

19. The computer program of claim 16 further including:
means for determining a purchaser's needs; and
wherein said set of quality attributes of said suppliers are based upon said purchaser's needs.

20. The computer program of claim 16 wherein at least one of said set of quality attributes involves the management processes of said supplier.
